(19) United States
(12) Patent Application Publication
(10) Pub. No.: US 2017/0175449 A1
(43) Pub. Date: Jun. 22, 2017

(54) ICE AUGER AND ADJUSTMENT PART FOR AN ICE AUGER

(71) Applicant: Rapala VMC Corporation, Helsinki (FI)

(72) Inventors: Jukka Roikonen, Säynätsalo (FI); Samuel Lehtonen, Korpilahti (FI)

(21) Appl. No.: 15/386,307

(22) Filed: Dec. 21, 2016

(30) Foreign Application Priority Data
Dec. 22, 2015 (EP) 15201831.3

(51) Int. Cl. E21B 10/44; A01K 97/01; E21B 7/02

(52) U.S. Cl. CPC E21B 10/44; E21B 7/02; A01K 97/01

(57) ABSTRACT

An ice auger having an adjustment part arranged in connection with a cutting blade of the ice auger for adjusting cutting characteristic of the cutting blade.

### PRIORITY INFORMATION

The present application claims priority to EP patent application 15201831.3 titled “Ice Auger and Adjustment Part for an Ice Auger” filed on Dec. 22, 2015.

### TECHNICAL FIELD

Generally, the invention relates to ice augers, and more specifically the invention relates to an adjustment part and/or cutting means of an ice auger.

### BACKGROUND

An ice auger is an essential tool in winter fishing for drilling a bore hole through ice. Usually, a bore crown at the end of an ice auger comprises at least two cutting blades, which are arranged to cut ice, when a drive shaft is rotated. A helix provided in connection with the drive shaft lifts the cut ice and slush away from the bore hole.

A known problem of ice augers is that different ice conditions require various ice augers having different characteristics. When drilling hard ice, an ice auger having a steep inclination angle of cutting blades is useful, because it can bite hard the ice. In other ice conditions, the same ice auger may bite the ice too hard, which can make drilling very laborious. For that reason, a user typically needs two or three ice augers having different cutting blade characteristics.

Producing ice augers with various cutting blade characteristics, e.g. having different cutting blade inclination angles, may also be difficult. The inclination angle of a cutting blade is usually determined by sharpening angle of the blade or by the shaping of the bore crown. This may require several work phases and/or various molds.

Some prior art solutions with adjustable cutting characteristics have been presented in patent publications. For example, U.S. Pat. No. 3,786,876 presents a particular type of ice auger wherein at the end of the shaft instead of a bore crown there is a connector part for attaching cutting blades with particular connecting pieces to said connector and wherein pins are used to set the cutting angle. Further, U.S. Pat. No. 3,797,588 discloses a solution where the crown of the auger is adjusted to set the blades fixed thereon. U.S. Pat. No. 3,131,777 discloses a solution where also the whole crown with cutting edges is bent with a particular arrangement to set the crown at different angles.

However, an improved ice auger is still needed that can adjust the cutting characteristic of the auger for several different ice environments.

### SUMMARY

Objects and advantages of the invention will be set forth in part in the following description, or may be obvious from the description, or may be learned through practice of the invention.

In one embodiment, the invention is implied to solve how to provide an ice auger suitable for different kinds of ice conditions.

According to an embodiment of the invention, an ice auger comprises an adjustment part arranged in connection with a cutting blade of said ice auger for adjusting cutting characteristic of the cutting blade. In one embodiment, the adjusted cutting characteristic of said cutting blade is adjusting an inclination angle of the cutting blade. In another embodiment, the adjusted characteristic of said cutting blade is limiting biting of said cutting blade by the form of said adjustment part. By adjusting the inclination angle of the cutting blade it can be selected how well the ice auger in question cuts ice. By limiting the biting of the cutting blade it can be affected how deep the cutting blade sinks into the ice. By limiting the biting may be possible to provide an ice auger that is lighter to use. Embodiments having both adjusted inclination angle and limited biting may provide an ice auger, which drills smoothly, but still efficiently, in every ice conditions.

The adjustment part is attached to said bore crown. In this way it may be possible to produce desired adjustment part and use existing molds for producing bore crowns. In an assembling phase, cutting blades and adjusting parts are attached to the bore crown. In one embodiment, the adjustment part is molded to be part of a bore crown of the ice auger. In this way, it may be possible to produce a mold having suitable bore crown form and, in an assembling phase, attach cutting blades to the bore crown.

Yet, in another embodiment, the adjustment part is formed in the cutting blade. In this embodiment, a cutting blade is produced so that it comprises the adjustment part. In this way, it may be possible to use existing molds for bore crowns and, in assembling phase, attach the cutting blade with the adjustment part in the bore crown.

Some preferable embodiments of the invention are described in the dependent claims.

Significant advantages can be achieved with the present invention when compared to the prior art solutions. The inclination angle of the cutting blade may be adjusted by using the adjustment part of the present invention. In this case, an edge of cutting blades can be sharpened into the same inclination angle, which may simplify the producing process. Respectively, forming of the bore crown may be kept simple and, depending on embodiment, it may not have to be amended.

The invention in question may enable producing of an ice auger, which can be used in every ice condition and which is efficient for drilling a bore hole through ice, but which is light to use, however. In this way, a user may not have to buy several ice augers with various cutting blade characteristics, but one ice auger is sufficient for every ice type.

Other features and aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, which includes reference to the accompanying figures, in which:

FIG. 1 illustrates a lower part of an ice auger according to an embodiment of the present invention;

FIG. 2 illustrates an explosion view of the ice auger in FIG. 1;

FIG. 3a illustrates a top view of an adjustment part according to an embodiment of the present invention;

FIG. 3b illustrates a bottom view of the adjustment part of FIG. 3a;

FIG. 3c illustrates a side view of the adjustment part of FIG. 3a;

FIG. 3d illustrates the adjustment part of FIG. 3a in a perspective view seen obliquely from below in one side of the adjustment part;

FIG. 3e illustrates the adjustment part of FIG. 3a in a perspective view seen obliquely from above in one side of the adjustment part;

FIG. 3f illustrates the adjustment part of FIG. 3a in a horizontal side view seen from one side of the adjustment part;

FIG. 3g illustrates the adjustment part of FIG. 3a in a perspective view seen obliquely from below in the other side of the adjustment part;

FIG. 3h illustrates the adjustment part of FIG. 3a in a perspective view seen obliquely from above in the other side of the adjustment part;

FIG. 3i illustrates the adjustment part of FIG. 3a in a horizontal side view seen from the other side of the adjustment part; and

FIG. 4 illustrates a principle of defining the inclination angle of a cutting blade. Repeat use of reference characters in the present specification and drawings is intended to represent the same or analogous features or elements of the present invention.

### DETAILED DESCRIPTION

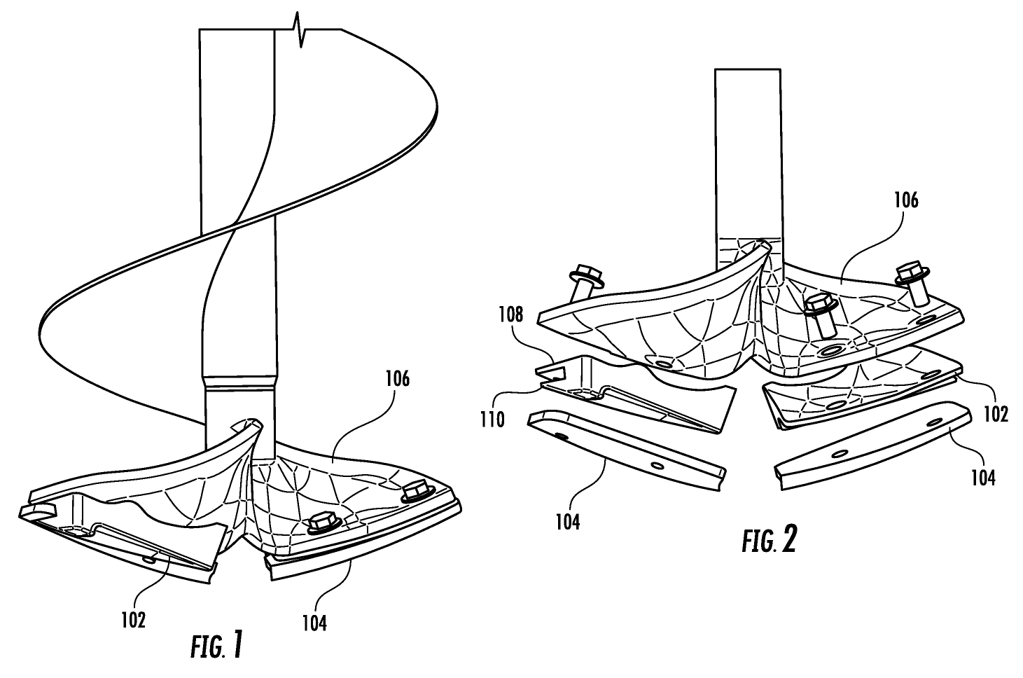

FIG. 1 illustrates a lower part of an ice auger according to an embodiment of the present invention, and FIG. 2 illustrates an explosion view of the ice auger in FIG. 1. In the shown embodiment, an ice auger includes an adjustment part 102 arranged to be in connection with a cutting blade 104 of the ice auger. The cutting blade 104 and the adjustment part 102 are attached in a bore crown 106 of the ice auger.

In one embodiment, the adjustment part 102 is arranged in between the crown 106 and the cutting blade 104. In one embodiment, the adjustment part 102 comprises an upper part 108 and a lower part 110. In one embodiment, the lower part 110 is placed upon the back end of the cutting blade, in other words, covering a part of the cutting blade 104.

In one embodiment, the adjustment part 102 is preferably formed so that it comprises an upper part 108, which is placed between the bore crown 106 and the cutting blade 104, and a lower part 110, which is placed upon the back end of the cutting blade, in other words, covering a part of the cutting blade 104.

Depending on the embodiment, the form of the adjustment part 102 can vary, and especially, the form of the lower part 110. Preferably, the lower part covers e.g. 50%-95% of the cutting blade, and more preferably e.g. 65%-85% of the blade.

In an embodiment, the inclination angle of the cutting blade is selected by forming the upper part 108 providing a desired inclination angle to the cutting blade. An upper surface of the upper part may be set against the surface of the bore crown and, advantageously, the form of the upper surface corresponds the surface form of the bore crown. The lower surface of the upper part is set against the cutter blade, and, respectively, the form of the lower surface corresponds the surface form of the cutting blade. In other words, upper part 108 of the adjustment part 102 may be formed to provide a predetermined inclination angle to a cutting blade 104 attached to the adjustment part 102 for instance by defining positioning of the upper surface and the lower surface of the upper part 108 in relation to one another.

In an embodiment, adjustment part 102 is fixed at the underside of the ice auger bore crown 106 as can be seen in FIG. 1 and FIG. 2, for example. In an embodiment, such an adjustment part 102 may be arranged in between the crown 106 and the cutting blade 104. In an embodiment, the adjustment part 102 may then set the cutting blade 104 to an angle in relation to the bore crown 106 of the ice auger. In other words, the cutting blade 104 may be arranged to an angle in relation to the bore crown 106 of the ice auger by means of the adjustment part 102. In a further embodiment, the adjustment part 102 may, thus, be arranged to connect ordinary cutting blades into an ice auger bore crown 106. As the angle affects the cutting properties of the ice auger, the adjustment part 102 may, in other words, be used to adapt the ice auger for different ice conditions. An advantage of such an embodiment is that the adjustment part 102 may act as a housing for cutting blades 104, which when connected to a typical ice auger bore crown, directly sets the cutting blade 104 to a certain cutting angle that is different from the cutting angle which would result from attaching the same cutting blade bit to the ice auger without the adjustment part 102.

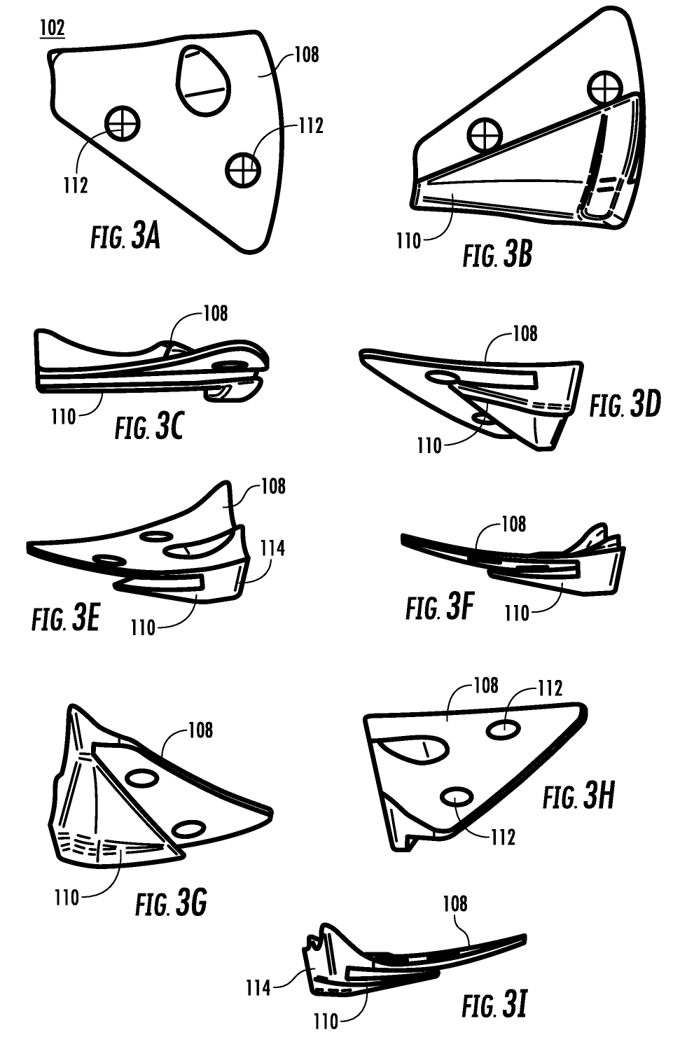

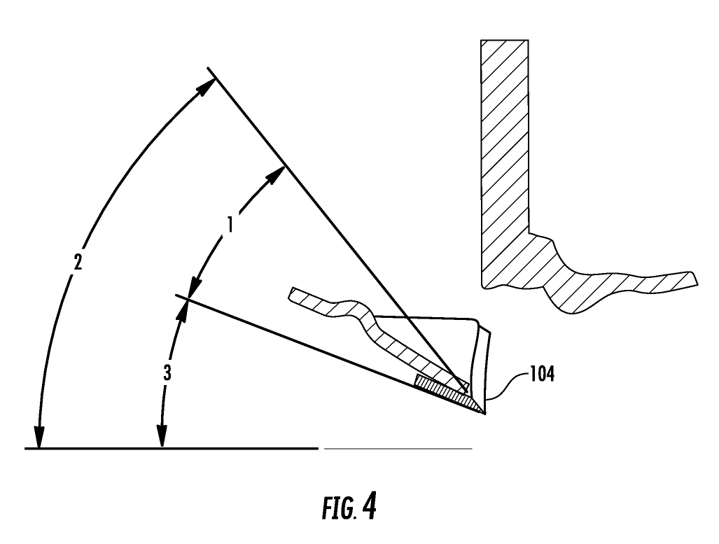

FIGS. 3a-3i depict an adjustment part according to an embodiment of the present invention in top, bottom and side views, seen obliquely from below and above in one and the other side, as well as in a horizontal side view seen from both sides.

According to an embodiment, the adjustment part 102 for an ice auger may be arrangeable in connection with a cutting blade 104 of the ice auger for adjusting cutting characteristic of the cutting blade. According to an embodiment, the adjusted cutting characteristic of the cutting blade may comprise selecting an inclination angle of the cutting blade. According to an embodiment, the adjusted characteristic of the cutting blade may comprise limiting biting of the cutting blade 104 by the form of the adjustment part 102. According to an embodiment, an adjustment part 102 may be formed to a cutting blade 104. According to a further embodiment, an adjustment part 102 may be attached to an ice auger, for instance to a bore crown 106 of an ice auger.

As can be seen in FIGS. 3a and 3h, the upper part 108 preferably comprises holes 112 for attaching the adjustment part and the cutting blade to the bore crown by using fastening means of the ice auger, like screws, for example.

The lower part 110 of the adjustment part forms a heel 114 to the cutting blade, as can be seen in FIGS. 3e and 3i. By selecting the thickness of the heel 114, it can be affected how deep the cutting blade bites the ice. When a cutter blade is set to a steeper inclination angle, the thickness of the heel 114 is selected to be thicker preventing the cutting blade to bite the ice to be drilled too deep. In a lower inclination angle, the thickness of the heel 114 can be less. In other words, the adjustment part 102 may comprise a heel 114 formed by the lower part 110 of the adjustment part 102 to a cutting blade 104 for an ice auger, and the thickness of the heel 114 may be selected based on the inclination angle the adjustment part 102 provides for the cutting blade 104 to affect how deep the cutting blade 104 bites the ice.

In FIG. 4, it is illustrated a principle of defining the inclination angle of a cutting blade 104. The angle 3 is the best to describe the inclination angle of a cutting blade. Because of function and the form of a bore crown, the angle 3 varies depending on the measuring point. As an exemplary definition of the inclination angle, the first measuring point a is a part nearest to the middle axis of the ice auger, the second measuring point b is in the middle of the cutting blade and the third measuring point c is a part farthest to the middle axis of the ice auger. As exemplary purposes only, the cutting blade can be said to have a lower inclination angle, i.e. being gently sloped, when a is about below 21° , b is about below 10° and c is about below 8° , for example. The steep inclination angle can be achieved, when the angle 3 in measuring points a, b and c exceeds previously mentioned values.

The form of the lower part can be selected so that the surface of the lower part does necessarily not have to be set against the surface of ice, when in a usage position, but only a part of the lower part is set against the surface of ice.

In embodiment depicted in FIGS. 3a-i, the adjustment part is a separate part, which can be attached to the bore crown and the cutting blade. In another embodiment, the adjustment part is molded to be part of a bore crown. In an embodiment, the adjustment part formed in the bore crown comprises only upper part, and, in another embodiment, the adjustment part formed in the bore crown comprises both the upper part and the lower part.

Yet, in another embodiment, the adjustment part is formed in the cutting blade. In an embodiment, the adjustment part formed in the cutting blade comprises only upper part, and, in another embodiment, the adjustment part formed in the cutting blade comprises both the upper part and the lower part.

Combination of these embodiments are also possible having the upper part formed in the bore crown and the lower part formed in the cutting blade, for example, or having a separate upper part or lower part and forming the another part either in the bore crown or in the cutter blade. In an embodiment, the both the upper part and the lower part are separate parts connected together by fastening means of the ice auger, for example.

The scope of the invention is determined by the attached claims together with the equivalents thereof. The skilled persons will again appreciate the fact that the explicitly disclosed embodiments were constructed for illustrative purposes only, and the scope will cover further embodiments, embodiment combinations and equivalents that better suit each particular use case of the invention.

What is claimed:

1. A blade adjustment arrangement for ice augers comprising an adjustment part arranged in connection with a cutting blade and with an ice auger for adjusting cutting characteristic of the ice auger, wherein said adjustment part is fixed at the underside of the ice auger bore crown in between said crown and the cutting blade, and wherein said adjustment part sets the cutting blade to an angle in relation to the bore crown of the ice auger.

2. The blade adjustment arrangement according to claim 1, wherein said adjusted cutting characteristic is selecting an inclination angle of said cutting blade in relation to the bore crown.

3. The blade adjustment arrangement according to claim 1, wherein said adjusted cutting characteristic is limiting biting of said cutting blade by the form of said adjustment part.

4. The blade adjustment arrangement according to claim 1, wherein said adjustment part is molded to be part of a bore crown of said ice auger.

5. The blade adjustment arrangement according to claim 1, wherein said adjustment part is formed to said cutting blade.
